(19) United States
(12) Patent Application Publication
(10) Pub. No.: US 2024/0015706 A1
(43) Pub. Date: Jan. 11, 2024

(54) COMMUNICATION DEVICE, COMMUNICATION METHOD, COMPUTER PROGRAM PRODUCT, AND COMMUNICATINO SYSTEM

(71) Applicant: KABUSHIKI KAISHA TOSHIBA, Tokyo (JP)

(72) Inventors: Yasuyuki TANAKA, Kawasaki Kanagawa (JP); Hiroki KUDO, Kawasaki Kanagawa (JP)

(73) Assignee: KABUSHIKI KAISHA TOSHIBA, Tokyo (JP)

(21) Appl. No.: 18/175,403

(22) Filed: Feb. 27, 2023

(30) Foreign Application Priority Data
Jul. 6, 2022 (JP) 2022-109021

(51) Int. Cl. H04W 72/0446; H04W 72/0453

(52) U.S. Cl. CPC H04W 72/0446; H04W 72/0453

(57) ABSTRACT

According to one embodiment, a communication device includes one or more processors. The one or more processors are configured to: determine a timing of time-division multiplexing data communication and a radio frequency to be used for the data communication based on a predetermined determination rule common to a plurality of communication devices included in a time-division multiplexing communication system, the predetermined determination rule using a number of hops from a specific communication device of the plurality of communication devices; and control wireless communication to be performed at the determined frequency at the determined timing.

### CROSS-REFERENCE TO RELATED APPLICATIONS

This application is based upon and claims the benefit of priority from Japanese Patent Application No. 2022-109021, filed on Jul. 6, 2022; the entire contents of which are incorporated herein by reference.

### FIELD

Embodiments described herein relate generally to a communication device, a communication method, a computer program product, and a communication system.

### BACKGROUND

In time-division multiplexing wireless communication, it is preferable to suppress interference caused when a plurality of nodes (communication devices) transmit data at the same time. For example, there has been proposed a technique of suppressing interference in a network by adjusting a time of a slot frame (a unit of a communication schedule) in advance according to a scale of the network.

In addition, there has been proposed a technique of monitoring a communication success rate of a slot in which data is transmitted, determining that there is another node transmitting data in the same slot when the communication success rate is lower than a predetermined value, and changing the transmission process of the own node so as to perform the transmission process in another slot.

However, in the related art, a communication device may exchange a control message (perform negotiation) with its communication counterpart.

### BRIEF DESCRIPTION OF THE DRAWINGS

FIG. 1 is a configuration diagram of a communication system according to a first embodiment;

FIG. 2 is a block diagram of a concentrator according to the first embodiment;

FIG. 3 is a diagram illustrating an example of a data structure of node information;

FIG. 4 is a diagram illustrating an example of a schedule unit;

FIG. 5 is a diagram illustrating an example of a communication schedule of the concentrator;

FIG. 6 is a block diagram of a functional configuration of a node according to the first embodiment;

FIG. 7 is a diagram illustrating an example of a communication schedule;

FIG. 8 is a flowchart of a communication process according to the first embodiment;

FIG. 9 is a configuration diagram of a communication system according to a second embodiment;

FIG. 10 is a block diagram of a node according to the second embodiment;

FIG. 11 is a configuration diagram of a communication system according to a third embodiment;

FIG. 12 is a block diagram of a concentrator according to the third embodiment;

FIG. 13 is a block diagram of a configuration of a node according to the third embodiment; and

FIG. 14 is a hardware configuration diagram of communication devices according to the embodiments.

### DETAILED DESCRIPTION

In general, according to one embodiment, a communication device includes one or more processors. The one or more processors are configured to: determine a timing of time-division multiplexing data communication and a radio frequency to be used for the data communication based on a predetermined determination rule common to a plurality of communication devices included in a time-division multiplexing communication system, the predetermined determination rule using a number of hops from a specific communication device of the plurality of communication devices; and control wireless communication to be performed at the determined frequency at the determined timing.

Hereinafter, exemplary embodiments of a communication device will be described in detail with reference to the accompanying drawings. The present invention is not limited to the following embodiments.

In the following embodiments, an autonomous communication scheduling algorithm based on the number of hops is adopted in the time-division multiplexing wireless communication control. The autonomous communication scheduling algorithm is, for example, an algorithm that does not require negotiation with a communication for notifying a slot used for communication. The autonomous communication scheduling algorithm is easy to implement, and is capable of suppressing control overhead (reducing negotiation load).

If a plurality of nodes transmit data in the same slot (at the same time), transmission signals of the plurality of nodes may interfere with each other, causing data loss or the like. In the autonomous communication scheduling algorithm, it is necessary to perform scheduling in such a manner as to avoid interference in the same network.

The embodiment adopts a linear topology in which one path is configured from a root node (concentrator 200) to a leaf node over a wireless multi-hop network. Each node recognizes the number of hops between itself and the root node when connected to the wireless multi-hop network. Using the number of hops, each node determines a slot and a frequency (channel) in which data communication is performed. Each node performs a data reception process in a slot in which another node transmits data thereto (one parent node and one child node in the linear topology).

According to the embodiment, even when a plurality of nodes transmit data in the same slot, the plurality of nodes may use different frequencies, or can be configured to be distant from each other on the network at the same frequency. As a result, it is possible to suppress interference in the same network.

### First Embodiment

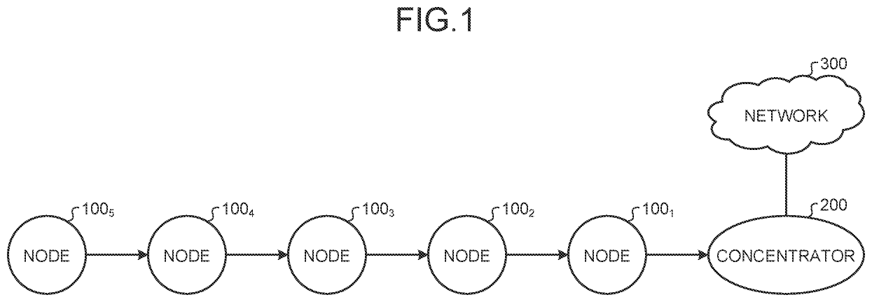

FIG. 1 is a diagram illustrating an example of a configuration of a communication system according to the present embodiment. As illustrated in FIG. 1, the communication system according to the present embodiment includes a concentrator 200 (an example of a communication device), a plurality of nodes 100₁ to 100₅ (an example of a communication device), and a network 300. Since the nodes 100₁ to 100₅ have a similar configuration, they will be simply referred to as nodes 100 in a case where they do not need to be distinguished from each other.

The concentrator 200 constitutes a wireless multi-hop network together with the nodes 100₁ to 100₅. As a wireless communication technique, Wi-Fi (registered trademark), Bluetooth (registered trademark), IEEE 802.15.4, or the like are used. In addition, a wireless multi-hop network control method is collection tree protocol (CTP), RPL (IETF RFC 6550), or the like. The wireless communication technique and the wireless multi-hop network control method are not limited thereto.

Each of the communication devices included in the communication system performs time-division multiplexing wireless communication. The concentrator 200 corresponds to a specific communication device (root node) among the plurality of communication devices included in the time-division multiplexing communication system.

The number of nodes 100 (node count) constituting the wireless multi-hop network as the concentrator 200 is one or more. The upper limit of the number of nodes is determined based on a wireless communication technique to be adopted, a restriction of a protocol of an upper layer in the wireless communication technique, and a requirement such as power consumption when the node 100 is driven by a battery.

In addition, the concentrator 200 may be connected to an external network different from the wireless multi-hop network including the network 300. The concentrator 200 may be connected to two or more external networks. The concentrator 200 may not be connected to an external network. The network 300 may be any type of network such as a local network, a field area network, or the Internet. The form of connection to the network 300 may be any of wired connection, wireless connection, and a combination of wired connection and wireless connection.

As described above, the topology of the wireless multi-hop network is a linear topology that forms one path from the concentrator 200, which is a root node, to the node 100 (the node 100₃ in FIG. 1), which is a leaf node.

In the linear topology, the nodes 100 constitute the multi-hop network in such a manner that each node sets one or less other nodes 100 as its parent node. For example, the node 100₁ has no other node 100 as its parent node because the concentrator 200 is its parent node, but each of the nodes 100₂ to 100₃ has one other node 100 as its parent node.

In addition, the nodes 100 constitute the multi-hop network in such a manner that each node sets one or less other nodes 100 as its child node. For example, the node 100₃ has no other node 100 as its child node because it is a leaf node, but each of the nodes 100₁ to 100₄ has one other node 100 as its child node.

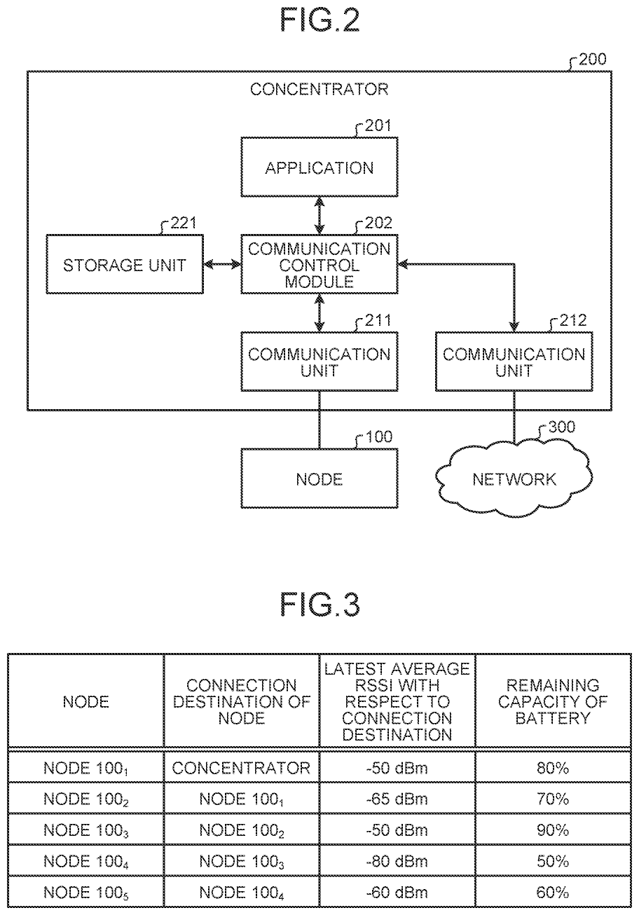

Next, an example of a functional configuration of the concentrator 200 will be described. FIG. 2 is a block diagram illustrating an example of a functional configuration of the concentrator 200. As illustrated in FIG. 2, the concentrator 200 includes an application 201, a communication control unit 202, communication units 211 and 212, and a storage unit 221.

The storage unit 221 stores various data used in the concentrator 200. For example, the storage unit 221 stores information (node information) regarding connected nodes 100. The storage unit 221 can be constituted by any generally used storage medium such as a flash memory, a memory card, a random access memory (RAM), a hard disk drive (HDD), or an optical disc.

The communication unit 211 communicates with another node 100 in the wireless multi-hop network. The communication unit 212 is used for communication with the network 300.

When connected to the network 300, the concentrator 200 includes the communication unit 212. When not connected to the network 300, the concentrator 200 may not include the communication unit 212. The communication unit 212 performs communication mainly to transmit and receive application data to and from the network 300 and maintain connection with the network 300.

The communication control unit 202 controls communication using the communication units 211 and 212. For example, the communication control unit 202 configures, manages, and maintains the wireless multi-hop network. In order to configure the wireless multi-hop network, the communication control unit 202 is operated periodically, randomly, according to a predetermined rule, or manually to advertise the wireless multi-hop network to a node 100 on the periphery thereof (hereinafter, a peripheral node). This advertisement is performed by transmitting data called a beacon or a control message.

In addition, when receiving a request for connection to the wireless multi-hop network from a peripheral node, the communication control unit 202 controls the connection of the peripheral node according to a predetermined procedure. The communication control unit 202 may perform an authentication process on the peripheral node at the time of the connection process, and permit the connection of the peripheral node when the authentication succeeds. The communication control unit 202 transmits a beacon, a control message, or the like to the connected node 100 at a predetermined timing to maintain synchronization between internal clocks of the concentrator 200 and the node 100 and check whether they are active with respect to each other.

The communication control unit 202 stores information (node information) regarding a node 100 (the node 100₁ in the example of FIG. 1) directly connected to the concentrator 200 in the storage unit 221. When it is confirmed that the node 100 has been disconnected from the concentrator 200 by checking whether the node 100 and the concentrator 200 are active with respect to each other or the like, the communication control unit 202 may delete the information stored in the storage unit 221. Information regarding not only the node 100 directly connected to the concentrator 200 but also all or some of the other nodes 100 in the wireless multi-hop network may be stored in the storage unit 221.

FIG. 3 is a diagram illustrating an example of a data structure of node information stored in the storage unit 221. In this example, the node information includes, for all the nodes 100 in the wireless multi-hop network, information regarding a node 100 or the concentrator 200 (parent node) to which the node 100 is connected, an average received signal strength indicator (RSSI) between the node and its connection destination, and a remaining capacity of a battery. The storage unit 221 may store other information for each of the connection destinations, or may store some of the information illustrated in FIG. 3.

Returning to FIG. 2, the communication control unit 202 controls wireless communication in a time-division multiplexing manner. In a case where the wireless communication technique is IEEE 802.15.4, time-slotted channel hopping (TSCH) may be considered as a time-division multiplexing method, but another control method may be used. In the communication control unit 202, a schedule unit of a time-division multiplexing communication schedule is set in advance.

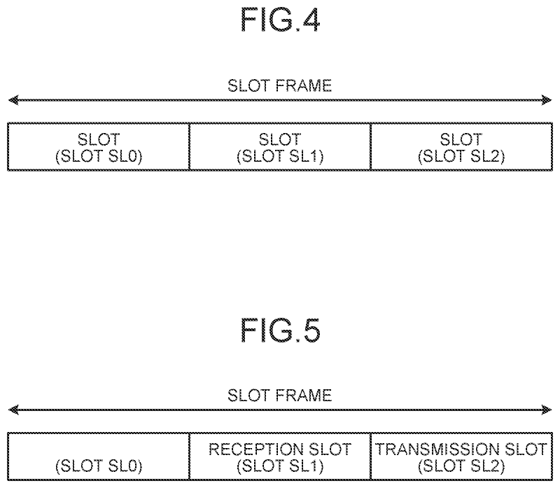

FIG. 4 is a diagram illustrating an example of a schedule unit. FIG. 4 is an example in which a slot frame is a schedule unit. The schedule unit is not limited thereto. For example, the schedule unit may be a super frame including a predetermined number of slot frames.

In the example of FIG. 4, a slot frame including three slots SL0, SL1, and SL2 is a schedule unit. The slots may have any length, such as 10 milliseconds, 50 milliseconds, or 100 milliseconds, but the slots in the slot frame have the same length. That is, if the head slot has a length of 10 milliseconds, each of the other slots also has a length of 10 milliseconds. Although three slots are included in the slot frame in FIG. 4, the number of slots in one slot frame is not limited to three. It is only needed that the slot frame includes at least two slots.

The communication control unit 202 allocates one slot in the slot frame for transmission of data from the corresponding node. The slot used for transmission of data will be referred to as a transmission slot. For example, the communication control unit 202 allocates the slot SL2 of FIG. 4 as a transmission slot. The communication control unit 202 allocates one of the slots before and after the transmission slot for reception of data from the node 100 connected to the concentrator 200. The slot before the slot SL2 is a slot SL1, and the slot after the slot SL2 is a slot SL0. The communication control unit 202 allocates one of the slot SL1 and the slot SL0 for reception of data. The slot used for reception of data will be referred to as a reception slot. For example, the communication control unit 202 allocates the slot SL1 of FIG. 4 as a reception slot. It is assumed that which one of the slots before and after the transmission slot is to be used as a reception slot is set in the communication control unit 202 in advance. FIG. 5 is a diagram illustrating an example of a communication schedule of the concentrator 200 assigned in this way.

The communication control unit 202 controls communication performed by the communication unit 211 according to the communication schedule. In the example of FIG. 5, neither transmission nor reception of data is allocated to the slot SL0, and thus the communication control unit 202 does not perform any process. The concentrator 200 may be configured so that the entire concentrator 200 is brought into a sleep state in such a slot to suppress power consumption.

Since reception of data is allocated to the slot SL1, the communication control unit 202 brings the communication unit 211 into a data reception standby state. When the node 100 connected to the concentrator 200 transmits data in the slot SL1, the concentrator 200 can receive the data in the slot SL1. The concentrator 200 may be configured so that, if it can be determined that no data is received in the slot SL1, the reception standby state of the communication unit 211 is released at that time to suppress power consumption. For example, when nothing can be received in a predetermined section (e.g., in 3 milliseconds from the start) of the slot SL1, the reception standby state of the communication unit 211 may be released. The communication control unit 202 causes the communication unit 211 to transmit data in the slot SL2. If there is no standby data to be transmitted, the communication control unit 202 does nothing in the slot SL2. The concentrator 200 may be configured so that the entire concentrator 200 is brought into a sleep state to suppress power consumption.

The communication control unit 202 may advertise the schedule unit of the communication schedule and information regarding the communication schedule of the concentrator 200 to peripheral nodes using a control message. When the communication control unit 202 does not perform advertisement, it is assumed that the schedule unit of the communication schedule set in the communication control unit 202 of the concentrator 200 or information regarding the communication schedule of the concentrator 200 is set in the node 100 by a certain means.

The application 201 executes a predetermined application process. The application process may be any process such as acquiring and transmitting sensor data, controlling an actuator, or transmitting a message to another device.

For example, the application 201 generates and transmits application data addressed to the node 100 in the wireless multi-hop network and application data addressed to the network 300. In addition, the application 201 may also receive application data from the node 100. For example, the application 201 may generate and transmit application data for operating an actuator included in the node 100 and changing the setting of the node 100. Furthermore, for example, the application 201 may receive sensor data acquired by a sensor included in the node 100, and transmit the sensor data collectively to the network 300.

Each of the above-described units (the application 201 and the communication control unit 202) is realized, for example, by one or more processors. For example, each of the above-described units may be realized by causing a processor such as a central processing unit (CPU) to execute a program, that is, by software. Each of the above-described units may be realized by a processor such as a dedicated integrated circuit (IC), that is, by hardware. Each of the above-described units may be realized by using software and hardware in combination. When a plurality of processors are used, each of the processors may realize one of the units or realize two or more of the units.

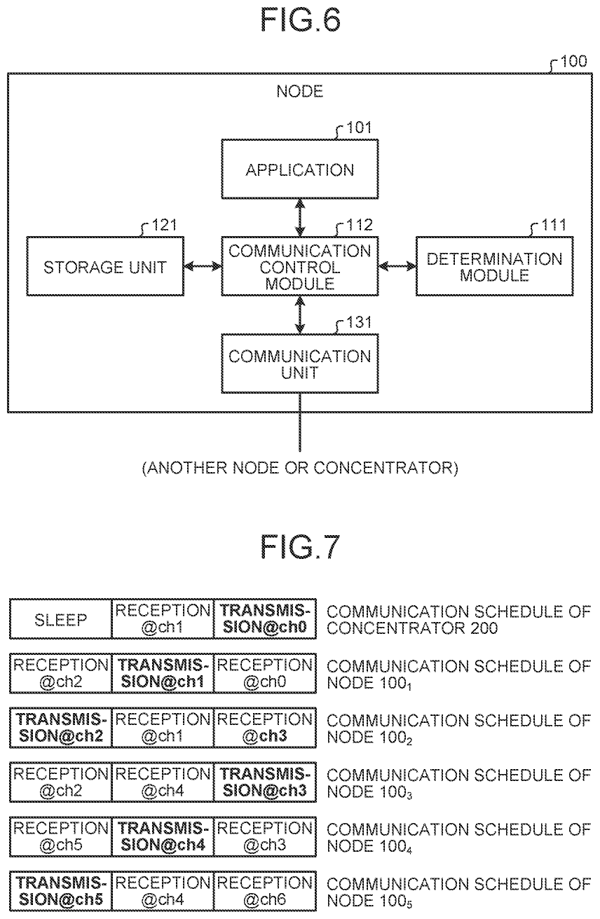

Next, a configuration of the node 100 will be described. FIG. 6 is a block diagram illustrating an example of a functional configuration of the node 100. As illustrated in FIG. 6, the node 100 includes an application 101, a determination unit 111, a communication control unit 112, a communication unit 131, and a storage unit 121.

The storage unit 121 stores various data used in the node 100. For example, the storage unit 121 stores information about another device to be connected to the node 100 (the concentrator 200 or another node 100). The storage unit 121 can be constituted by any generally used storage medium such as a flash memory, a memory card, a RAM, an HDD, or an optical disk.

The communication unit 131 communicates with another node 100 in the wireless multi-hop network or the concentrator 200.

The application 101 executes a predetermined application process. The application process may be any process, and is, for example, a process corresponding to the application 201 of the concentrator 200 (acquiring and transmitting sensor data, controlling an actuator, or transmitting a message to another device).

The communication control unit 112 controls communication using the communication unit 131. For example, when recognizing the presence of the wireless multi-hop network by receiving a beacon or the like, the communication control unit 112 transmits a request for connection to another node 100 in the wireless multi-hop network. The connection process varies depending on what wireless communication technique and what wireless multi-hop network control method are used. For example, the communication control unit 112 transmits and receives some control messages, and in some cases, performs an authentication process. When they succeed, the node 100 can be connected to one of the devices (the node 100 or the concentrator 200) in the wireless multi-hop network. The node 100 may be directly connected to the concentrator 200, or may be connected to another node 100.

The node 100 recognizes what itself is located in the wireless multi-hop network based on a control message transmitted and received when the node 100 is connected to the wireless multi-hop network.

For example, the node 100₁ of FIG. 1 recognizes that it is directly connected to the concentrator 200, and it is located at the first hop in the wireless multi-hop network from the perspective of the concentrator 200. In addition, the node 100₅ also recognizes that it is connected to the node 100₄ and it is located at the fifth hop in the wireless multi-hop network from the perspective of the concentrator 200. The information regarding connection in the wireless multi-hop network is stored, for example, in the storage unit 121. For example, the node 100₂ stores the following information in the storage unit 121.
Connection destination node (parent node): the node 100₁
Distance (the number of hops) from the concentrator 200: 2
Latest average RSSI with respect to the connection destination: −65 dBm

The communication control unit 112 transmits all or some of the information stored in the storage unit 121 to the connection destination using a control message or the like. Furthermore, the communication control unit 112 receives similar information from the node 100 connected to the corresponding node. The received information may be further transmitted to the connection destination of the corresponding node.

The communication control unit 112 recognizes a schedule unit of a communication schedule used in the wireless multi-hop network by receiving a control message or by manually performing a setting. In addition, the communication control unit 112 also recognizes the position of the transmission slot and the position of the reception slot of the concentrator 200.

The position of the slot is indicated, for example, by a slot number indicating a position of each slot in the slot frame. Hereinafter, it is assumed that positions of slots are indicated by slot numbers starting from 0, such as 0, 1, . . . , and N−1 (N is the number of slots in the slot frame).

The determination unit 111 determines a timing of time-division multiplexing data communication (e.g., a transmission slot or a reception slot) and a radio frequency used for the data communication, based on a predetermined determination rule using at least the number of hops, which is common to each of the devices (the concentrator 200 and the nodes 100) included in the communication system. For example, the determination rule under which the determination unit 111 decides a slot number of a transmission slot, a slot number of a reception slot, and a radio frequency of the corresponding node from the number of hops of the corresponding node, the slot number of the transmission slot of the concentrator 200, and the slot number of the reception slot of the concentrator 200 will be described in detail below.

The communication control unit 112 controls wireless communication using the determined frequency at the timing of data communication (e.g., in a transmission slot and a reception slot) determined by the determination unit 111.

Each of the above-described units (the application 101, the determination unit 111, and the communication control unit 112) is realized, for example, by one or more processors. For example, each of the above-described units may be realized by causing a processor such as a CPU to execute a program, that is, by software. Each of the above-described units may be realized by a processor such as a dedicated integrated circuit (IC), that is, by hardware. Each of the above-described units may be realized by using software and hardware in combination. When a plurality of processors are used, each of the processors may realize one of the units or realize two or more of the units.

Next, the determination rule will be described in detail. For example, the determination unit 111 determines a slot number SLₛ of one transmission slot as follows. A slot number of a transmission slot of the concentrator 200 is denoted by S, a slot number of a reception slot of the concentrator 200 is denoted by R, the number of slots in a slot frame is N, and the number of hops between the concentrator 200 and the corresponding node 100 is denoted by h.

In the case of (S−1)mod N=R (where the reception slot of the concentrator 200 is located before the transmission slot of the concentrator 200):

SLₛ=(S−h)mod N

In the case of (S+1)mod N=R (the reception slot of the concentrator 200 is located after the transmission slot of the concentrator 200):

SLₛ=(S+h)mod N

In addition, the communication control unit 112 determines slot numbers SL_{R1} and SL_{R2} of two reception slots using the determined slot number SLₛ of the transmission slot.

SL_{R1}=(SLₛ−1)mod N

SL_{R2}=(SLₛ+1)mod N

In this manner, the slot number of the transmission slot of the node 100 is calculated from the number h of hops and the number N of slots in the slot frame, and the slot number of the reception slot of the node 100 is calculated from the transmission slot of the node 100. The node 100 has one transmission slot and two reception slots. In this case, the determination rule can be interpreted as a rule for determining a slot (timing of data communication) using the number of hops and the number of the plurality of slots included in the slot frame.

The communication control of the transmission slot, the reception slot, and the slot to which no process is assigned is similar to the operation of the communication control unit 202 of the concentrator 200.

Next, a method of determining a frequency to be used for data communication (determination rule) will be described. Each of the concentrator 200 and the nodes 100 determines a frequency to be used according to the number of hops h thereof when transmitting data in the transmission slot. For example, when the number of available frequencies (the number of channels) is denoted by C, the determination unit 111 of the node 100 determines a number (hereinafter, a channel number) CHₛ for identifying a frequency to be used in the transmission slot using the number of hops h as follows.

CHₛ=h mod C

In this case, the determination rule can be interpreted as a rule for determining a frequency to be used for data communication using the number of hops and the number of the plurality of available frequencies.

By using information in which a channel number and a frequency are associated with each other (e.g., an array in which a channel number is used as an index and a frequency corresponding to the index is stored), the determination unit 111 can determine a frequency corresponding to a channel number.

The method of determining a frequency is not limited thereto, and any method may be used as long as the frequency is determined according to the number of hops. For example, the determination unit 111 may calculate a channel offset using the number C of available channels and the number of hops of the corresponding node 100, and determine a frequency by frequency hopping using the channel offset. For example, IEEE 802.15.4-2020 has proposed a method of determining a frequency by frequency hopping using a channel offset and an absolute slot number (ASN) equivalent to a current time in a network. By using such a method, the determination unit 111 may determine a frequency using the number of hops, the number of frequencies, and information indicating a current slot (e.g., an ASN).

In this case, the determination rule can be interpreted as a rule for determining a frequency to be used for data communication using the number of hops, the number of the plurality of available frequencies, and the information indicating a current slot.

For example, the determination unit 111 determines a channel offset OFFₛ to be used in the transmission slot as follows.

OFFₛ=h mod C

The determination unit 111 determines a frequency or a channel offset to be used in the reception slot in a similar manner. Hereinafter, an example of how to determine channel numbers CH_{R1} and CH_{R2} of frequencies to be used in the reception slots having slot numbers SL_{R1} and SL_{R2}, respectively, will be described below.

In the case of (S−1)mod N=R (where the reception slot of the concentrator 200 is located before the transmission slot of the concentrator 200)

CH_{R1}=(h+1)mod C

CH_{R2}=(h−1)mod C

In the case of (S+1)mod N=R (the reception slot of the concentrator 200 is located after the transmission slot of the concentrator 200)

CH_{R1}=(h−1)mod C

CH_{R2}=(h+1)mod C

Each of the concentrator 200 and the nodes 100 independently performs the communication control as described above, so that the entire wireless multi-hop network can perform communication according to communication schedules as illustrated in FIG. 7. FIG. 7 is a diagram illustrating an example of a communication schedule.

In the example of FIG. 7, the number N of slots in a slot frame is three, and the number C of channels is seven or more. In addition, ch0 to ch6 indicate channel numbers. In addition, in the example of FIG. 7, the slot number of the transmission slot of the concentrator 200 is 2, and there is a reception slot whose slot number is 1 before the transmission slot of the concentrator 200. This corresponds to the above-described case of (S−1)mod N=R.

Since each of the nodes 100 uses a common determination rule under which a slot number and a frequency are determined according to the number of hops, each of the nodes 100 can perform scheduling that avoids interference in the wireless multi-hop network without exchanging control messages (performing negotiation) with the other devices. Note that the above-described determination rule is an example, and is not limited thereto. Any rule may be used as long as the determination rule is common to each of the devices while using at least the number of hops.

In a case where the number of slots is smaller than the number of nodes, interference can be suppressed because a plurality of nodes 100 can be scheduled to use different frequencies even if they perform data communication in the same slot. In addition, an insufficient number of frequencies may cause a plurality of nodes 100 to perform data communication at the same frequency. However, the plurality of nodes 100 can be scheduled so that the same frequency is used between the nodes 100 having a difference in the number of hops corresponding to the number of frequencies, that is, the same frequency is used between the nodes 100 distant from each other on the network. As a result, it is possible to suppress interference in the same network.

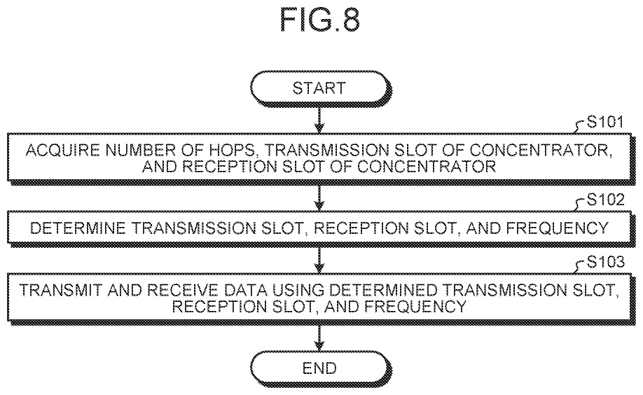

Next, a communication process performed by the communication system according to the first embodiment will be described. FIG. 8 is a flowchart illustrating an example of a communication process according to the first embodiment.

The communication control unit 112 is connected to the wireless multi-hop network to acquire the number of hops from the concentrator 200, a slot number of a transmission slot of the concentrator 200, and a slot number of a reception slot of the concentrator 200 (step S101).

Using the acquired number of hops and the acquired slot numbers, the determination unit 111 determines a slot number of a transmission slot, a slot number of a reception slot, and a radio frequency of the corresponding node according to the above-described determination rule (step S102).

The communication control unit 112 transmits and receives data using the transmission slot having the determined slot number, and the reception slot having the determined slot number, and the determined frequency (step S103).

As described above, in the communication device according to the first embodiment, a timing of time-division multiplexing data communication and a radio frequency are determined based on the predetermined determination rule common to each of the devices included in the communication system. As a result, it is possible to realize wireless communication in which interference in the network is suppressed while negotiation load is reduced.

### Second Embodiment

In a second embodiment, a configuration including a node connected to two or more other nodes will be described. A concentrator may also be connected to two or more nodes.

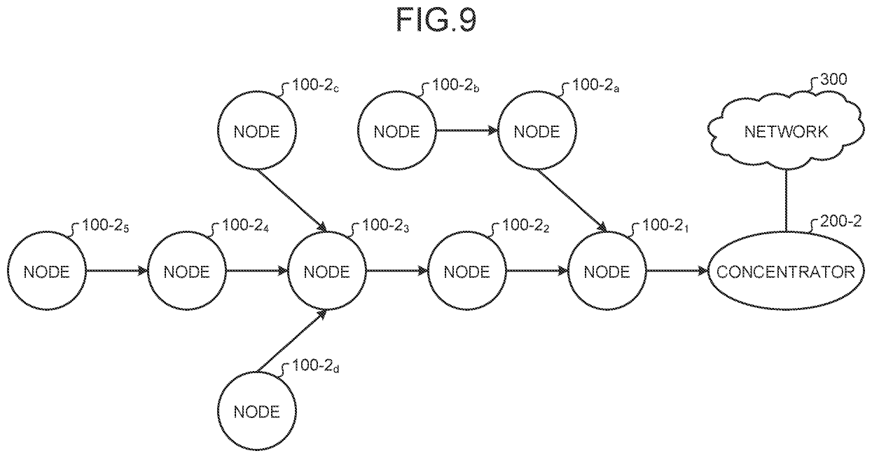

FIG. 9 is a diagram illustrating an example of a configuration of a communication system according to the second embodiment. As illustrated in FIG. 9, the communication system according to the present embodiment includes a concentrator 200-2, a plurality of nodes 100-2₁ to 100-2₅ and 100-2ₐ to 100-2_{d}, and a network 300. Since the nodes 100-2₁ to 100-2₅ and 100-2ₐ to 100-2_{d} have a similar configuration, they will be simply referred to as nodes 100-2 in a case where they do not need to be distinguished from each other.

As illustrated in FIG. 9, the node 100-2₁ is connected to the node 100-2₂ and the node 100-2ₐ. In addition, the node 100-2₃ is connected to the node 100-2₄, the node 100-2_{c}, and the node 100-2_{d}. As described above, the communication system according to the present embodiment includes the node 100-2₁ and the node 100-2₃ each connected to two or more other nodes 100-2.

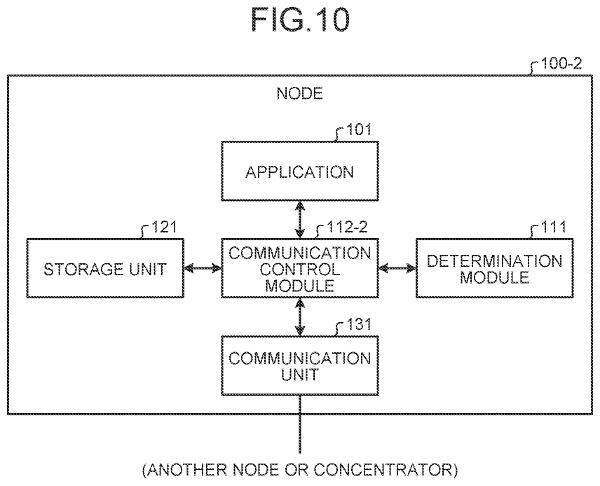

FIG. 10 is a block diagram illustrating an example of a configuration of the node 100-2 according to the second embodiment. As illustrated in FIG. 10, the node 100-2 includes an application 101, a determination unit 111, a communication control unit 112-2, a communication unit 131, and a storage unit 121.

In the second embodiment, the communication control unit 112-2 has a different function from that in the first embodiment. The other configurations and functions are similar to those in FIG. 6, which is a block diagram of the node 100 according to the first embodiment, and thus, are denoted by the same reference numerals to omit the description thereof here.

Since the function of the determination unit 111 is similar to those in the first embodiment, the same slot and frequency are determined, for example, for the node 100-2₄, the node 100-2_{c}, and the node 100-2_{d} having the same number of hops. Therefore, in the present embodiment, in a case where there is another node 100-2 having the same number of hops, the communication control unit 112-2 adjusts a timing at which data is generated or transmitted together with the communication control unit 112-2 of the another node 100-2, so that the plurality of nodes 100-2 do not transmit data at the same timing. Note that such adjustment may be performed by the application 101. Hereinafter, a case where such adjustment is performed by the communication control unit 112-2 will be described as an example.

In FIG. 9, for example, since the node 100-2₂ and the node 100-2ₐ have the same number of hops, they have the same slot as a transmission slot. Times or time zones when the two nodes 100-2 are allowed to transmit data are set to be separated from each other in advance so that the two nodes 100-2 do not transmit data at the same time.

For example, the communication control unit 112-2 specifies whether or not there is another node 100-2 having the same number of hops, from information or the like obtained when connected to the wireless multi-hop network. In a case where there is another node 100-2 having the same number of hops, the communication control unit 112-2 controls communication so that the corresponding node performs data communication at a different time from the another node 100-2 having the same number of hops. For example, the communication control unit 112-2 controls the corresponding node to perform data communication at a time or in a time zone appointed in advance to be different from that of the another node 100-2.

The time or the time zone may be appointed by any appointment method. For example, the time or the time zone can be appointed by applying a method using an absolute time or a method using a slot number or a slot frame number managed to monotonously increase with the lapse of time.

The communication control unit 112-2 may control the corresponding node to perform data communication at a time or in a time zone different from those of the other nodes 100-2 in accordance with a predetermined rule (time determination rule). This rule is, for example, a rule for calculating a time or a time zone when data can be transmitted, from information for identifying the node 100-2, an interface address, a network address, and the like allocated to the node 100-2. For example, the communication control unit 112-2 may control the corresponding node so that data can be transmitted every hour at 10 minutes past the hour when a remainder obtained by dividing the information for identifying the node 100-2 by 60 is 10, or so that data can be transmitted every hour at 35 minutes past the hour when a remainder obtained by dividing the information for identifying the node 100-2 by 60 is 35.

As described above, in the second embodiment, even when a communication system includes a node connected to two or more other nodes, interference in the network can be suppressed.

### Third Embodiment

In a third embodiment, an example in which a plurality of communication paths are configured between communication devices (a concentrator and nodes) will be described.

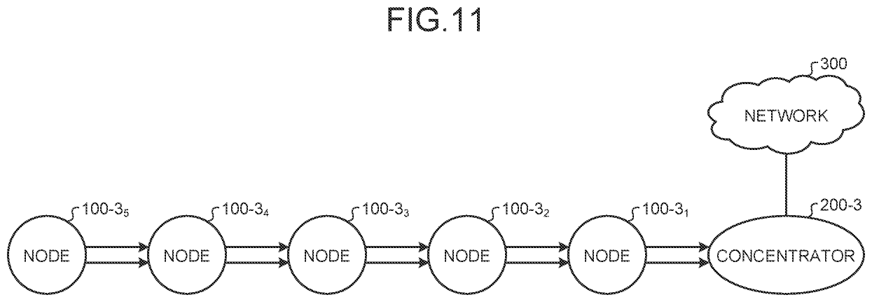

FIG. 11 is a diagram illustrating an example of a configuration of a communication system according to the third embodiment. As illustrated in FIG. 11, the communication system according to the present embodiment includes a concentrator 200-3, a plurality of nodes 100-3₁ to 100-3₅, and a network 300. Since the nodes 100-3₁ to 100-3₅ have a similar configuration, they will be simply referred to as nodes 100-3 in a case where they do not need to be distinguished from each other.

As illustrated in FIG. 11, in the present embodiment, a wireless multi-hop network is configured so that the concentrator 200-3 and the nodes 100-3 are connected to each other by two communication paths. That is, in the present embodiment, the concentrator 200-3 and nodes 100-3 have two communication paths using two communication units. One communication path is a communication path PA including a communication unit 211 of the concentrator 200-3 and a communication unit 131 of each node 100-3. The other communication path is a communication path PB including a communication unit 211-3 (to be described below) of the concentrator 200-3 and a communication unit 131-3 (to be described below) of each node 100-3.

In the present embodiment, frequencies in different ranges are allocated to the two communication paths. For example, among a plurality of available frequencies, frequencies having first half channel numbers are allocated to the communication path PA, and frequencies having second half channel numbers are allocated to the communication path PB. The frequency assignment method is not limited thereto. For example, frequencies whose channel numbers are even numbers and frequencies whose channel numbers are odd numbers may be allocated to the communication path PA and the communication path PB, respectively.

The frequency used by each node 100-3 within the assigned frequency range is determined by the same manner as in the above-described embodiment.

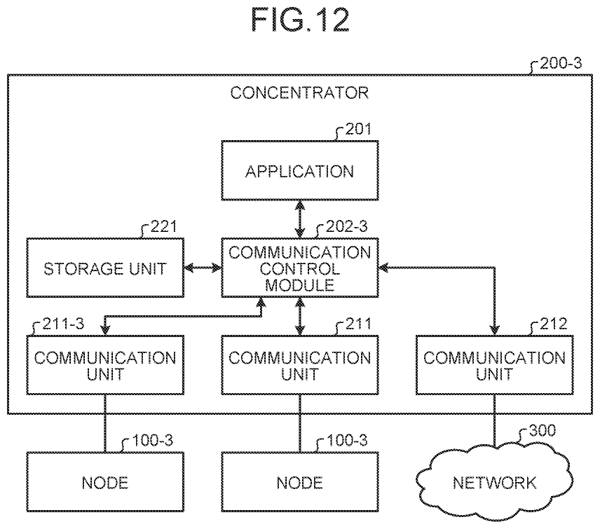

FIG. 12 is a block diagram illustrating an example of a functional configuration of the concentrator 200-3 according to the third embodiment. As illustrated in FIG. 12, the concentrator 200-3 includes an application 201, a communication control unit 202-3, communication units 211, 211-3, and 212, and a storage unit 221.

The third embodiment is different from the first embodiment in the function of the communication control unit 202-3 because the communication unit 211-3 is added. The other configurations and functions are similar to those in FIG. 2, which is a block diagram of the concentrator 200 according to the first embodiment, and thus, are denoted by the same reference numerals to omit the description thereof here.

Similarly to the communication unit 211, the communication unit 211-3 communicates with another node 100-3 in the wireless multi-hop network. As described above, the communication unit 211 is used in the communication path PA, and the communication unit 211-3 is used in the communication path PB.

The communication control unit 202-3 controls communication using the communication unit 211-3 in addition to the communication units 211 and 212.

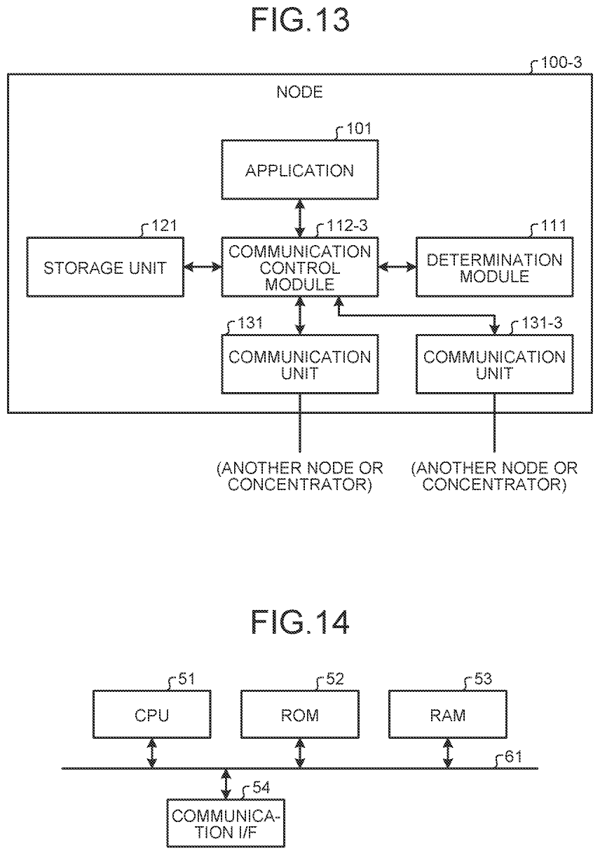

FIG. 13 is a block diagram illustrating an example of a configuration of the node 100-3 of the third embodiment. As illustrated in FIG. 13, the node 100-3 includes an application 101, a determination unit 111-3, a communication control unit 112-3, communication units 131 and 131-3, and a storage unit 121.

The third embodiment is different from the first embodiment in the functions of the determination unit 111-3 and the communication control unit 112-3 because the communication unit 131-3 is added. The other configurations and functions are similar to those in FIG. 6, which is a block diagram of the node 100 according to the first embodiment, and thus, are denoted by the same reference numerals to omit the description thereof here.

Similarly to the communication unit 131, the communication unit 131-3 communicates with another node 100 in the wireless multi-hop network or the concentrator 200. As described above, the communication unit 131 is used in the communication path PA, and the communication unit 131-3 is used in the communication path PB.

The determination unit 111-3 determines frequencies to be used within the frequency range assigned for each of the two communication paths PA and PB. For example, for the communication path PA, the determination unit 111-3 determines frequencies by the procedure similar to that in the above-described embodiment, the number of frequencies allocated to the communication path PA being C. Similarly, for the communication path PB, the determination unit 111-3 determines frequencies by the procedure similar to that in the above-described embodiment, the number of frequencies allocated to the communication path PB being C.

The communication control unit 112-3 controls communication using the communication unit 131-3 in addition to the communication unit 131.

In the present embodiment, while the communication control as in the first embodiment is executed, different frequencies are used as described above. Note that the concentrator 200-3 and the nodes 100-3 may have three or more communication paths. Each of the concentrator 200-3 and the nodes 100-3 may include communication units of which the number corresponds to the number of communication paths.

As described above, in the third embodiment, interference in the network can be suppressed even in the configuration including a plurality of communication paths between the devices.

As described above, according to the first to third embodiments, it is possible to suppress interference in the network while reducing negotiation load.

Next, a hardware configuration of the communication device according to each of the first to third embodiments will be described with reference to FIG. 14. FIG. 14 is an explanatory diagram illustrating an example of a hardware configuration of the communication device according to each of the first to third embodiments.

The communication device according to each of the first to third embodiments includes a control device such as a CPU 51, a storage device such as a read only memory (ROM) 52 and a RAM 53, a communication I/F 54 connected to a network to perform communication, and a bus 61 connecting the units to each other.

A program executed by the communication device according to each of the first to third embodiments is incorporated in the ROM 52 or the like in advance for provision.

The program executed by the communication device according to each of the first to third embodiments may be recorded in a computer-readable recording medium, such as a compact disk read only memory (CD-ROM), a flexible disk (FD), a compact disk recordable (CD-R), or a digital versatile disk (DVD), as a file in an installable format or in an executable format, and provided as a computer program product.

Furthermore, the program executed by the communication device according to each of the first to third embodiments may be stored on a computer connected to a network such as the Internet, and downloaded via the network for provision. In addition, the program executed by the communication device according to each of the first to third embodiments may be provided or distributed via a network such as the Internet.

The program executed by the communication device according to each of the first to third embodiments can cause a computer to function as each of the units of the communication device described above. In this computer, the CPU 51 can read the program from the computer-readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
one or more processors configured to:
determine a timing of time-division multiplexing data communication and a radio frequency to be used for the data communication based on a predetermined determination rule common to a plurality of communication devices included in a time-division multiplexing communication system, the predetermined determination rule using a number of hops from a specific communication device of the plurality of communication devices; and
control wireless communication to be performed at the determined frequency at the determined timing.

2. The device according to claim 1, wherein the one or more processors are configured to, based on the determination rule using the number of hops and a number of a plurality of slots included in a slot frame, determine one of the plurality of slots as the timing of the data communication.

3. The device according to claim 1, wherein the one or more processors are configured to, based on the determination rule using the number of hops and a number of a plurality of available frequencies, determine one of the plurality of frequencies as the frequency to be used for the data communication.

4. The device according to claim 1, wherein the one or more processors are configured to, based on the determination rule using the number of hops, a number of a plurality of available frequencies, and information indicating a current slot, determine one of the plurality of frequencies as the frequency to be used for the data communication.

5. The device according to claim 1, wherein the plurality of communication devices constitute a multi-hop network in such a manner that each communication device sets one or less communication devices of the plurality of communication devices as a parent node.

6. The device according to claim 1, wherein the plurality of communication devices constitute a multi-hop network in such a manner that each communication device sets one or less communication devices of the plurality of communication devices as a child node.

7. The device according to claim 1, wherein the one or more processors are configured to control wireless communication to be performed at the determined frequency at the determined timing in such a manner that the data communication is performed at a time different from a time of data communication performed by another communication device having the same number of hops.

8. The device according to claim 1, wherein
the plurality of communication devices are connected to each other by a plurality of communication paths,
the plurality of communication paths are assigned with frequencies in different ranges, and
the one or more processors are configured to, for each of the plurality of communication paths, determine the frequency to be used for the data communication among the frequencies included in the frequency ranges.

9. A computer program product comprising a non-transitory computer-readable medium including programmed instructions, the instructions causing a computer to execute:
determining a timing of time-division multiplexing data communication and a radio frequency to be used for the data communication based on a predetermined determination rule common to a plurality of communication devices included in a time-division multiplexing communication system, the predetermined determination rule using a number of hops from a specific communication device of the plurality of communication devices; and
controlling wireless communication to be performed at the determined frequency at the determined timing.

10. A communication system comprising a plurality of communication devices,
each of the communication devices, other than a specific communication device of the plurality of communication devices, comprising:
one or more processors configured to:
determine a timing of time-division multiplexing data communication and a radio frequency to be used for the data communication based on a predetermined determination rule common to the plurality of communication devices, the predetermined determination rule using a number of hops from the specific communication device; and
control wireless communication to be performed at the determined frequency at the determined timing.

11. A communication method executed by a communication device, the method comprising:
determining a timing of time-division multiplexing data communication and a radio frequency to be used for the data communication based on a predetermined determination rule common to a plurality of communication devices included in a time-division multiplexing communication system, the predetermined determination rule using a number of hops from a specific communication device of the plurality of communication devices; and
controlling wireless communication to be performed at the determined frequency at the determined timing.
